(19) United States
(12) Patent Application Publication
(10) Pub. No.: US 2004/0248996 A1
(43) Pub. Date: Dec. 9, 2004

(54) Sodium petroleum sulfonate blends as emulsifiers for petroleum oils

(75) Inventors: Michael T. Costello, Southington, CT (US); Igor Riff, Waterbury, CT (US); Rebecca F. Siebert, Oxford, CT (US); Joseph A. Weaver JR., Torrington, CT (US)

Correspondence Address: Michael P. Dilworth, Crompton Corporation, Benson Raod, Middlebury, CT, 06749, US

(73) Assignee: CROMPTON CORPORATION

(21) Appl. No.: 10/862,236

(22) Filed: Jun. 7, 2004

Related U.S. Application Data
(60) Provisional application No. 60/476,620, filed on Jun. 9, 2003.

(51) Int. Cl. C09K 3/00

(52) U.S. Cl. 516/58

(57) ABSTRACT

An emulsifier composition suitable for mixing with oil to make lubricants is disclosed that comprises:

A) at least one product of the sulfonation of at least one of the following feedstocks:

i) a petroleum oil,

ii) a straight chain monoalkylbenzene,

iii) a straight chain dialkylbenzene,

iv) a branched chain monoalkylbenzene, and

v) a branched chain dialkylbenzene, and

B) at least one straight or branched chain alkylaryl sulfonate salt.

### BACKGROUND OF THE INVENTION

1. Field of the Invention

The present invention relates to emulsifier compositions that can be used as replacements for natural high molecular weight sodium petroleum sulfonate.

2. Description of Related Art

Sodium petroleum sulfonates are widely used as the primary emulsifiers in formulating emulsifiable lubricating compositions used for cutting fluid, hydraulic fluids, metalworking lubricants, and the like.

Petroleum sulfonate, along with white oil, is traditionally produced commercially from the treatment of raffinate with fuming sulfuric acid. It has been used in metal working applications, with an annual volume of up to 40 million pounds for the North American market and twice that much worldwide.

The traditional process for the production of the white oil and petroleum sulfonate is complicated and potentially hazardous owing to the utilization of hazardous materials and the formation, and consequent necessary disposal, of hazardous by-products. These two factors strongly affect the cost of petroleum sulfonate, and, without modification, may put the production and supply of this vital product in jeopardy.

Sodium petroleum sulfonates are typically produced as by-products of refining processes in which certain highly refined petroleum products, such as white lubricating oils, medicinal oils, and certain grades of transformer oils, are produced. The highly refined petroleum products are produced by treating a refined petroleum distillate or raffinate with fuming sulfuric acid, which reacts with certain components of the oil to produce sulfonic acids, some of which are oil-soluble and some of which are water-soluble, thus forming a two-phase system. The two phases separate into two layers—one of which is an oil layer containing oil-soluble, reddish-brown or mahogany, sulfonic acids, and the other a water-soluble layer commonly referred to as an acid sludge layer that contains resinous materials, unreacted sulfuric acid, and water-soluble or green sulfonic acids. The layers are then separated and the oil-soluble sulfonic acids are recovered from the oil layer, usually in the form of their sodium salts.

The mahogany sulfonic acids, being preferentially oil-soluble, have found wide use in the preparation of emulsifiable petroleum products, such as soluble cutting oils, hydraulic fluids, metalworking lubricating fluids for the forming of metals, and the like. The acid oil layer is neutralized to make a sodium salt and extracted with a polar solvent, typically alcohol, to separate most of the oil phase, and to increase the activity of the sodium petroleum sulfonate. This type of process is discussed generally in U.S. Pat. No. 1,930,488.

The manufacture of white oils by the above process has become increasingly uneconomical and, as a result, the production of the sulfonate by-products of white oil refining is substantially declining. This has left a significant shortage of sodium petroleum sulfonates.

Another major disadvantage with the natural petroleum sulfonates is their inconsistency in quality, which produces variability in their emulsifying properties. In order to improve emulsification properties, secondary surface active agents of different types, e.g., fatty acid salts, are often added. The amount of the secondary surface active agent used varies depending on the quality of the sulfonate being employed.

U.S. Pat. No. 3,959,399 discloses the inhibition of polyalkyl and specially dialkyl naphthalenes in the alkylation of naphthalene using an alkene reactant to produce monoalkyl naphthalene, by the use of a mixed protonic acid catalyst consisting of methane sulfonic acid and an active P₂O₅ containing acid, utilized in about a 2:1 to 1:2 ratio with an optimum ratio of about 1:1. The reaction is carried out preferably under anhydrous conditions with respect to the mixed catalyst, and the products are said to show utility as emulsion breakers in petroleum chemistry as well as other surface active agents.

U.S. Pat. No. 4,140,642 discloses emulsifier compositions, suitable for mixing with mineral oil to form metal working lubricants, that comprise a mixture of salts of alkylaryl sulfonic acids, said acids having a molecular weight distribution with two distinct peaks, one peak being preferably in the range of 270 to 400, while the other peak is in the range of 350 to 600; which peaks differ at least 80. The equivalent weights of the acids are distributed according to a function of C=f(M) where C denotes the concentration and M denotes the equivalent weight of individual acids, which function has two distinct equivalent weight maxima, M₁ and M₂, with M₁<M₂. Mixtures of 5 to 95 wt. % sodium salts of branched chain C₁₂ to C₁₆ alkyl orthoxylenesulfonic acids with 95 to 5 wt. % sodium salts of branched chain C₂₀ to C₂₈ alkyl benzenesulfonic acids are said to be especially preferred compositions, particularly when blended with naphthenic mineral oil, to thereby form stable emulsifiable metal working lubricants

U.S. Pat. No. 4,482,755 discloses the production of 4,4′-biphenol and tert-alkyl substituted alkyl benzene derivatives by hydrogenating a tetraalkyl diphenoquinone in an alkyl benzene solvent solution under relatively mild conditions in the presence of a heterogeneous catalyst, removing the catalyst from the resultant tetraalkyl biphenol and thereafter heating the alkyl benzene solvent solution in the presence of a strong acid catalyst to form relatively pure biphenol in highly yields and a para substituted alkyl benzene derivative.

U.S. Pat. No. 4,873,025 discloses compositions comprising alkylxylene sulfonate compounds of the formula

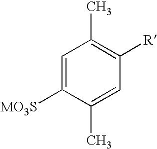

wherein R′ represents a C₆ to C₂₀ alkyl group and wherein M represents a hydrogen, a metal, an ammonium or an amine ion. These compositions are said to be useful as surfactants, particularly in enhanced oil recovery techniques.

U.S. Pat. No. 5,889,137 discloses the formation of phenol alkylation polymers which release negligible phenol and formaldehyde emissions. The phenol aralkylation polymers are derived from a phenolic monomer, at least one styrene derivative and an aryl diolefin. In addition to the phenolic monomer, styrene derivative and aryl diolefin, other reactants may be introduced to produce a product with particular properties.

U.S. Pat. No. 6,043,391 discloses anionic surfactants, and methods for their preparation, that are derived from aromatic or substituted aromatic molecules and alkenesulfonic acid. The aryl compound is alkylated and sulfonated in one-step with an alkene sulfonic acid prior to sulfonic acid neutralization. The methods are said to allow the functional sulfonate group to be attached to the end of the alkyl chain rather than to the aromatic ring thus allowing for selective substituted groups, either branched, linear or alkoxylated or combinations thereof to be placed oil the aryl compound prior to sulfonation and alkylation. The alkene sulfonic acid produced from thin-film sulfonation of an alpha-olefin is used to alkylate benzene, mono-substituted aromatic, poly-substituted aromatic, alkylbenzene, alkoxylated benzene, polycyclic aromatic, mono-substituted polycyclic aromatic, poly-substituted polycyclic aromatic, naphthalene, alkylnaphthalene, phenol, alkylphenol, alkoxylated phenol, and alkoxylated alkylphenolalkyl substituted or polysubstituted cyclic or polycyclic compounds to produce the corresponding sulfonic acid having an additional alkyl group derived from the alpha-olefin used during the thin-film sulfonation which is either linear or branched.

U.S. Pat. No. 6,225,267 discloses an emulsifier composition suitable for mixing with oil to form lubricants comprising at least one non-extracted salt of a natural petroleum sulfonic acid having about 15 wt-% to about 30 wt-% active content; at least one branched chain alkylaiyl sulfonic acid or salt thereof; at least one linear alkylaryl sulfonic acid or salt thereof, and optionally at least one other sulfonic acid or salt thereof for adjusting the average equivalent weight of the resultant emulsifier composition.

Published European Patent Application 0 121 964 A1 discloses alkyl aryl sulfonate concentrate compositions and provides a process wherein an aqueous solution containing at least 10% w/w of a neutralizing agent is mixed with at least one C₂₋₉ saturated alcohol and the resulting mixture is used to neutralize a C₈₋₁₈ alkyl aryl (xylene or toluene) sulfonic acid, relative quantities being such that the resulting neutralized mixture contains 5 to 40 parts by weight of the at least one alcohol per 100 part by weight of alkyl aryl sulfonate salt. The resulting flowable liquid concentrate compositions are said to be easily handled materials having application in enhanced oil recovery processes.

U.S. Pat. No. 3,959,399, supra, refers to George A. Olah, Friedel-Crafts and Related Reactions, Vol. 2, Part 1, 1964, Interscience-Wiley, pages 1-31; 69-71; and 180-186. Inter alia, this reference discusses the cationic nuclear alkylation of various aromatics such as monocyclic and polycyclic hydrocarbons, phenols, amines, thiophenes, furans, etc., with simple olefins including, the aryl-substituted olefins, styrene, and allylbenzene, etc. In the paragraph bridging pages 24 and 25, it is disclosed that strong protonic acids are very effective catalysts for the reaction of olefins with aromatics. Sulfuric acid, phosphoric acid, alkanesulfonic acids, and hydrogen fluoride are said to be effective catalysts for the condensation of benzene with propene.

The disclosures of the foregoing are incorporated herein by reference in their entirety.

### SUMMARY OF THE INVENTION

In the following description, certain designations are employed for convenience. They are listed here:

Emulsion Test Method for Sulfonates—use either a 10% or 20% emulsion in de-ionized water or a 90/10 white oil/sulfonate blend.

Rust Test Methods for Sulfonates—If the emulsion displayed fair to good performance, the rust test was performed. (Note: performing a rust test on a negative emulsion can yield unreliable results). The procedure used was similar to a modified ASTM D4627 method. The details are as follows:

1. The emulsion tested was a 95/5 de-ionized water/soluble oil base blend, of which the soluble oil base was composed of an 80/20 white oil/sulfonate blend.

2. The test was conducted using 2.0 grams of iron chips placed in a 10 mm×35 mm plastic petri dish.

3. The emulsion was poured over the iron chips to immerse the chips completely and fill the petri dish (5-10 mL).

4. The emulsion was left to stand in the petri dish for 20 minutes and was then drained by gentle shaking to remove excess liquid from the iron chips.

5. The iron chips were then left overnight (16-24 hours) uncovered in the petri dish and evaluated as either passing (no rust) or failing (rust). In rare cases, only a few chips were rusted, in which case the chips were counted and, if there were less than 10 rusted chips, we this was recorded as a marginal pass (no rust).

In some cases the candidate PSR, particularly synthetic materials, did not emulsify with Natural D at a 70/30 ratio, so experiments were run at a 80/20, 85/15, and 90/10 ratios to evaluate their emulsion and rust performance.

Synthetic Linear A—synthetic straight chained mono- and dialkylbenzene sulfonate, sodium salt (equivalent weight 430) (Aristonate L from Pilot Chemical);

Synthetic Linear B—synthetic straight chained mono- and dialkylbenzene sulfonate, sodium salt (equivalent weight 460) (Aristonate M from Pilot Chemical);

Synthetic Linear C—synthetic straight chained mono- and dialkylbenzene sulfonate, sodium salt (equivalent weight 520) (Aristonate H from Pilot Chemical);

Synthetic Linear D—synthetic straight chained benzene sulfonate, sodium salt (Fongrapol PSSR from Clariant);

Synthetic Linear E—synthetic straight chained benzene sulfonate, sodium salt (Manas S-301 from Naveen Additives Ltd.);

Synthetic Linear F—synthetic straight chained benzene sulfonate, sodium salt (Sansul 455 from Kimes);

Synthetic Branched A—synthetic sodium sulfonate salt of branched chain monoalkylbenzene (520 equivalent weight) (Synacto 246 from Infineum);

Synthetic Branched B—a synthetic sodium sulfonate salt of dodecyl ortho-xylene (390 equivalent weight) (Synacto 476 from Infineum);

Natural A—natural sodium petroleum sulfonate (580-600 equivalent weight) (Petrosul HX-60 from Penreco);

Natural B—natural sodium petroleum sulfonate (540-560 equivalent weight) (Petronate HH from Crompton);

Natural C—natural sodium petroleum sulfonate (520-560 equivalent weight) (Petronate L from Crompton);

Natural D—natural sodium petroleum sulfonate (460-480 equivalent weight) (Petronate HL-1 from Crompton);

Natural E—natural sodium petroleum sulfonate (415-445 equivalent weight) (Petronate L from Crompton);

Natural F—a product of the sulfonation of 600 SUS petroleum oil typically made from Exxon Americas Core 600 (approx. 550-580 equivalent weight);

Natural G—natural sodium sulfonate (Sulfol 430 from Matsumura Oil Research Co. Japan);

Natural H—natural sodium sulfonate (Sulfol 465 from Matsumura Oil Research Co. Japan);

Natural I—natural sodium sulfonate (from Zhuhai DaCheng Chemical Co.);

Natural J—natural sodium sulfonate (from Zhuhai DaCheng Chemical Co.);

Syn/Nat Blend A—a product of the co-sulfonation of the following mixture of feedstocks:

54.0-58.0% of a 600 SUS petroleuin oil (typically made from Exxon Americas Core 600);

24.0-28.0% of a straight chained (approx. C₁₂-C₁₄) dialkylbenzene (V9050 from Vista Chemical);

16.0-19.0% of a straight chained (approx. C₂₀-C₂₄) monoalkylbenzene (Aristol AW from Pilot Chemical);

Syn/Nat Blend B—a product of the co-sulfonation of the following mixture of feed stocks:

54.0-58.0% of a 600 SUS petroleum oil (typically made from Exxon Americas Core 600);

42.0-46.0% of a straight chained (approx. C₁₂-C₁₄) dialkylbenzene (V9050 from SASOL Chemical).

The properties of Americas Core 600 are:

| Property | Limit | Method | Typical |
|---|---|---|---|
| Appearance | | Visual | B&C |
| ASTM Color | Max | ASTM D 1500 | 3 |
| Flash Point, COC Deg C. | Min | ASTM D 92 | 246 |
| Kinematic Viscosity @ | Min-Max | ASTM D 445 | 109.0-116.5 |
| 40° C. mm²/sec | | | |
| Pour Point Deg C. | Max | ASTM D 97 | −6 |
| Viscosity Index | Min | ASTM D 2270 | 95 |

There is currently a projected shortage of high equivalent weight natural sodium petroleum sulfonate (e.g., Natural C) in both North America and Europe. Accordingly, the present inventors initiated a study to determine a replacement that would provide adequate rust protection while not adversely affecting the emulsion stability of metalworking fluids.

The performance match for any replacement of petroleum sulfonate (referred to hereinafter as “petroleum sulfonate replacement” or “PSR”) in metal working applications is typically developed from a basic formula that contains at least three ingredients: oil-soluble emulsifier, water-soluble emulsifier, and solvent. The solvent is normally paraffin oil, which is used for to provide the fluidity of the PSR. The final formula of the PSR may contain other ingredients, each used to satisfy a secondary function, e.g., coupling, anti-foaming, solid boosting, and the like.

In accordance with the present invention, a preferred PSR is a blend, preferably 50/50, of Syn/Nat Blend A and Synthetic Branched A (EW 520), which possessed a fair emulsion at 70/30 with Natural D and passed the rust test (ASTM D4627). This performance was analogous to the performance of high equivalent weight natural sodium petroleum sulfonate.

Another preferred PSR is a blend of:

A) about 10-20% by weight of a blend of 44% dialkylbenzene (V9050 from SASOL Baltimore, Md.) and 56% 600 SUS oil (ExxonMobil Americas Core 600) co-sulfonated and made into a 62% active sodium sulfoniate, havin(, an equivalent weight of about 527 (Syn/Nat Blend B); and, corresponidingly,

B) about 80-90% by weight of Synthetic Branched A.

Still another preferred PSR is a blend of:

A) about 30% by weight of a blend of 44% dialkylbenzene (V9050 from SASOL Baltimore, Md.) and 56% 600 SUS oil (ExxonMobil Americas Core 600) co-sulfonated and made into a 62% active sodium sulfonate, having an equivalent weight of about 527 (Syn/Nat Blend B); and

B) about 70% by weight of Synthetic Branched B.

More particularly, the present invention is directed to an emulsifier composition suitable for mixing with oil to make lubricants comprising:

A) at least one product of the sulfonation of at least one of tile following feedstocks:

i) a petroleum oil,

ii) a straight chain monoalkylbenzene,

iii) a straight chain dialkylbenzene,

iv) a branched chain monoalkylbenzene, and

v) a branched chain dialkylbenzene; and

B) at least one straight or branched chain alkylaryl sulfonate salt, preferably a member selected from the group consisting of monoalkylbenzenes and alkyl ortho-xylenes.

In another embodiment, the present invention is directed to a lubricating or cutting fluid composition comprising:

A) a composition comprising:

at least one product of the sulfonation of at least one of the following feedstocks:

a) a petroleum oil,

b) a straight chain monoalkylbenzene,

c) a straight chain dialkylbenzene,

d) a branched chain monoalkylbenzene, and

e) a branched chain dialkylbenzene; and

ii) at least one straight or branched chain alkylaryl sulfonate salt; and

B) at least one oil selected from the group consisting of paraffinic and naphthenic petroleum oil and paraffinic and naphthenic refined petroleum oil in an amount about 50 wt % to about 95 wt % of the total oil based composition.

### DESCRIPTION OF THE PREFERRED EMBODIMENTS

To be suitable for applications requiring petroleum sulfonate, a replacement must fulfill the following requirements:

1. It must be a clear liquid and with no precipitating material or sediment.

2. It must offer the same performance as that of petroleum sulfonate in the end-users' applications.

3. It should be able to replace the petroleum sulfonate directly without requiring changes or adjustments of the end-users' formulas.

4. Its activity should preferably be in the range of 59-62%.

5. It must provide adequate rust protection.

The natural petroleum sulfonic acid/salt employed in the practice of the present invention can be prepared by the sulfonation of the aromatics contained in natural petroleum, e.g., a typical lube base oil of 15-400 cSt viscosity at 40° C. The acid oil is de-sludged by gravity settling and neutralized with any monovalent cation from a base, preferably sodium. Preferably, the product is not extracted or solvent-treated to remove oil or salts. The process can thus be simplified over previously used processes for preparing natural petroleum sulfonic acid salts for use in emulsifier compositions.

This first component of the composition of the present invention is a natural petroleum sulfonic acid or sulfonate salt prepared using sulfuric acid, oleum, (i.e., fuming sulfuric acid), and/or sulfur trioxide or other sulfonating agent to sulfonate petroleum oil, preferably a paraffinic oil. One preferred oil for use herein is a typical lube base oil of 15-4000 cSt @40° C. The acid oil is de-sludged by settling using natural gravitational forces and is subsequently neutralized to about a 15-30%, preferably about a 20-30%, active petroleum sulfonate in oil. No further extraction or processing for the removal of oil or salts is necessary. These non-extracted natural sulfonates, as neutral salts, provide corrosion protection properties to metal and assist in emulsification performance.

The natural petroleum sulfonates preferably used as a first component of the present invention are very economical to produce owing to the minimum amount of processing required. The preferred paraffinic oil feed stream is low cost and in abundant supply. The sulfonates can be blended with other sulfonate emulsifiers to produce a product of preferably 60% or greater active content, for instance with highly active sulfonic acids. An example of a natural sodium petroleum sulfonate of this type is sodium petroleum sulfonate, Natural F, a 30% active sulfonic acid salt supplied by Crompton Corp. in Greenwich, Conn.

A preferred example of a natural petroleum product that can be sulfonated is commercially available from Exxon Corporation under the designation EXXON 3278, which is understood to be a blend of paraffin and sulfonatable alkylarenes. One means for preparing sulfonated EXXON 3278 is as follows.

First the feedstock (EXXON 3278) is subjected to an over-sulfonation in an impact jet reactor. While the over-sulfonation process yields the maximum amount of active product, it also results in the formation of a significant quantity of the disulfonate product, a component of “sludge”. To remove this sludge, the acid stream coining out of the reactor is mixed with heptane (to solubilize the active and the free oil) and concentrated sulfuric acid (to solubilize the sludge). Upon standing, the sulfuric acid/sludge layer separates and is removed, and the heptane product layer is washed with water to reduce its free sulfuric acid content. This product layer is then neutralized and the heptane is removed by distillation.

The petroleum sulfonic acid salts may be either inorganic or organic. The preferred inorganic salts are sodium salts. However, ammonium salts, or those of other metals, especially alkali or alkaline earth metals, can also be used. Inorganic compounds that can be employed include, but are not limited to, those comprising barium, calcium, lithium, rubidium, cesium, magnesium, potassium, sodium, strontium, radium, zinc, iron, copper, aluminum, and the like. Sodium is, however, the preferred metal for use herein.

Organic bases that can be employed include nitrogen bases, for example, primary, secondary, or tertiary amines, polyamines, alkanolamines including monoethanolamine, diethanolamine, triethanolamine, mixtures thereof, and the like.

The natural petroleum sulfonates are usefully employed in the compositions of the present invention in amounts of from about 10 wt % to about 70 wt %, preferably about 20 wt % to about 60 wt % of the total emulsifier composition, and more preferably from about 30 wt % to about 50 wt % of the total composition.

The highly active sulfoniates for use in combination with the natural petroleum sulfonates of the present invention are carefully selected so as to balance the oil compatibility, and the emulsification performance of the resultant emulsifier blend.

The preferred embodiments of materials to replace currently commercially available high equivalent weight sodium petroleum sulfonates (hereinafter, for convenience, referred to as HMW-PS), e.g., Natural C, include a mixture of natural and synthetic sulfonates of the compositions:

1. A 50/50 blend of Synthetic Branched A with a feedstock from Syn/Nat Blend A production.

2. A blend of Syn/Nat Blend B with Synthetic Branched A (10-20/90-80) or Synthetic Branched B (30/70).

The emulsifier compositions of the present invention also comprise, as a second component, at least one straight or branched chain alkylaryl sulfonate. Branched chain alkylaryl sulfonates have been known to exhibit improved solubility and emulsion stability and are discussed in U.S. Pat. No. 4,140,642, which is incorporated herein by reference in its entirety. Aryl groups include benzene, toluene, naphthalene, xylene, and the like. In a preferred embodiment of the present invention, the branched chain alkylaryl sulfonic acid is an alkylation product of benzene and olefin, olefin oligomer, e.g., polypropylene or polyisobutylene, or a mixture thereof.

The branched chain alkylaryl sulfonate is suitably employed in an amount from about 5 to about 40 wt %, preferably from about 10 wt % to about 30 swt % ofthe total composition, more preferably about 10 wt % to about 20 wt %. and most preferably about 11-14% (95% active). A specific branched alkylaryl sulfonate is WITCO® 1298H, a branched dodecylbenzene sulfollic acid supplied by Crompton Corp. The branched alkyl group of the alkylaryl sulfonlic acid may be a C₈ to C₃₀ alkyl, preferably C₈ to C₂₄, and more preferably a C₁₀ to C₂₄ alkyl.

Alternatively, the second component of the inventive composition, as noted above, can be a linear alkylaryl sulfonate. Again, suitable aryl groups include benzene, toluene, xylene, naphthalene, and the like, preferably benzene, toluene, or xylene, more preferably xylene, most preferably o-xylene.

The linear chain alkylaryl sulfonates are preferably used in amounts of about 5 to about 50 wt % of the total active sulfoniates, more preferably from about 10 wt % to about 50 wt %, and most preferably fironii about 20 to about 30 wt %.

The alkyl groups of these linear alkylaryl sulfonates are preferably C₈ to C₃₀ alkyl, more preferably C₈ to C₂₄, and most preferably from about C₁₀ to about C₂₄ alkyl. A specific preferred linear alkylaryl sulfonate is an alkylxylene sulfonate, more specifically monoalkylxylene sulfonate, and in particular, dodecylxylene sodium sulfonate, a high active content (about 70 wt % in salt form) sodium sulfonate. This material may also be supplied in a non-neutralized acid form (90-95 wt % active content).

These linear alkylaryl sulfonates contribute the attributes of a low equivalent weight component while maintaining complete solubility in oil. These materials are preferred because they are registered for use on both the TSCA and the DSL inventories.

These alkylaryl sulfonates, both branched and linear, can be prepared using standard sulfonation techniques, which typically involve sulfonation of the appropriate aromatic hydrocarbons, thereby obtaining the alkylaryl sulfonic acids, which are then subsequently neutralized with a base.

The alkylation may be carried out using any method known to one of skill in the art including a Friedel-Crafts reaction using an alkyl halide, alkanol, or alkene reactant in the presence of a Lewis acid catalyst. Catalysts may include hydrogen fluoride and activated clay.

The compositions of the present invention may optionally further comprise other alkylaryl sulfonates or sulfonic acid salts selected from a wide variety of highly active natural and synthetic sulfonic acids or salts, including medium, high, and very high equivalent weight sodium petroleum sulfonic acids and salts thereof, low, medium, and high equivalent weight synthetic sodium sulfonic acids or salts thereof, such as ARISTONATE® L, M and H (salt form) and ARISTONIC® L, M and H (acid form); high equivalent weight branched and linear alkylbenzene sulfonic acids and salts thereof where the side chain is C₁₄ to C₃₀; and the sodium salts of sulfonated C₁₀ to C₁₄ alkylation bottoms.

The bottoms material is manufactured starting from an alkylate. The alkylate is typically produced as a product of an alkylation process and may be referred to as alkylation bottoms, a distillation residue from the alkylation process. One such process from which this by-product material can be produced is from the dodecylation of benzene. Dodecylbenzene is distilled off and the alkylates remaining can be used to produce the sodium sulfonates of the present invention. The alkylate is sulfonated to a high purity sulfonic acid which is subsequently neutralized with an alkali metal hydroxide, for instance, sodium hydroxide, to the salt form. These compounds are useful in adjusting the equivalent weight or other performance parameters. An objective of the present invention is to replace a natural petroleum sulfonate that is prepared in the standard way, i.e., as a by-product of the white oil refining process, which includes an extraction process, with a blend of sulfonates in order to achieve the same performance. For example, these compounds may be used to adjust the equivalent weight of the total emulsifier composition to a low equivalent weight of about 400 g/mole, or to adjust it to a high equivalent weight of about 500 g/mole. Materials having an equivalent weight of less than about 400 are typically not sufficiently oil soluble for such applications. Materials having an equivalent weight of greater that about 500 g/mole, while exhibiting good corrosion properties, typically exhibit poor emulsion performance.

Petroleum sulfonates classified as low (L) equivalent weight petroleum sulfonates typically have an equivalent weight of about 410-440 g/mole, while those classified as medium (HL, referred to in this fashion because it was typically supplied as a blend of low and high equivalent weight petroleum sulfonates) equivalent weight petroleum sulfonates typically have an equivalent weight of about 450-480 g/mole and those classified as high (H) equivalent weight petroleum sulfonates typically have an equivalent weight of about 490-520 g/mole.

These general equivalent weight ranges apply to both synthetic and natural petroleum sulfonates, and work well for a range of metalworking applications.

Preferably, the sulfonates have an active content of about 55-65% or more, and up to about 95% active content.

These sulfonates are useful from up to about 20 wt % of the total fluid concentrate, and preferably from about 5 wt % to about 15 wt. % of the total composition. A specific example of a useful sulfonate is Petronate HL, a 62% active sodium petroleum sulfonate.

The components of the present invention are selected so as to produce a composition of emulsifiers that is completely soluble in petroleum or refined petroleum oils. Preferably, a paraffinic petroleum oil is used. For instance, a white mineral oil may be chosen such as Carnation® White mineral oil available from Crompton Corp. in Greenwich, Conn.

The emulsifier composition of the present invention may be added to a petroleum oil in an amount of about 10 wt % to about 50 wt % of the total mixture, which resultant oil based composition may be used as a cutting fluid for metalworking, for example. For such applications, it is desirable that the petroleum oil used, paraffinic or naphthenic, have a viscosity from about 5 to about 100 cSt at 40° C. These petroleum oils, in addition to the emulsifier composition of the present invention, may comprise from about 0 wt % to about 30 wt % fatty acid soap, 1 wt % to about 30 wt % of one or more extreme pressure lubricating agents, fromi about 1 wt % to about 20 wt % of one or more other anti-corrosion agents; and from 0.1 wt % to about 3 wt % of one or more bactericidal agents. Those of skill in the lubricant art will have knowledge of additional agents that may be added to the fluid. The cutting fluid concentrate is then dispersed in water, producing a stable aqueous emulsion for metalworking.

The compositions of the present invention also find use in other petroleum oil based compositions, particular those used for industrial applications, such as hydraulic fluids, grinding fluids, rust preventive fluids, drawing fluids, rolling fluids, oil-in-water and water-in-oil emulsions, and the like.

### EXAMPLES

The evaluation of potential HMW-PS replacement candidates has been hampered by the absence of a direct method to determine both emulsion stability and rust. It was observed that a 70/30 mixture of Natural D and HMW-PS exhibited a good emulsion and provided excellent rust protection. It was determined that any potential PSR should possess these properties, so blends of potential candidates were made at 70/30 to judge the emulsion performance by the Emulsion Test Method for Sulfonates.

In the metalworking, industry the ASTM procedure for rust evaluation of a soluble oil (ASTM D4627) requires an emulsion with very little cream. However, in the emulsion test for sodium sulfonates there is often up to 10 mL of cream. This excess cream can often result in inconsistent results. Therefore, the preferred method to evaluate rust performance was to use an 80/20 white oil/sulfonate blend in order to reduce the cream and provide a more consistent result.

In some cases, the candidate PSR, particularly synthetic materials, did not emulsify with Natural D at the 70/30 ratio, so the preferred method was to run experiments at a 90/10 ratio to evaluate their emulsion and rust performance.

### Results and Discussion

Many PSRs were evaluated that were both synthetic and natural from many external and internal sources. The results of the evaluation are presented in Table 1 and can be summarized as follows:

1. The emulsion performance of both samples of Natural F (both 28 and 62 active) and Syn/Nat Blend A at 70/30 (in Natural D) were negative. Addition of Synthetic Branched B did not improve the emulsion in Natural D. At the 90/10 ratio the emulsion was fair (without the addition of Synthetic Branched B), however the rust was a failure.

2. The Synthetic Lineal D, Synthetic Linear C, Synthetic Linear F, and Synthetic Linear E sulfonates all failed the rust test.

3. The best result was a 50/50 blend of Syn/Nat Blend A and Synthetic Branched A, which possessed a fair emulsion at 70/30 with Natural D and passed the rust test. This performance was analogous to the performance of HMW-PS.

4. A Syn/Nat Blend A sample was blended 80/20 with Synthetic Branched B. This was blended 70/30 in Natural D and possessed a poor emulsion and a marginally passing rust test.

TABLE 1

| | | 98- | | 98- | | | | | | 99- |
|---|---|---|---|---|---|---|---|---|---|---|
| Formulation | Active | 13 | 98-12 | 14 | 98-19 | 99-20 | 98-17 | 98-20 | 99-21 | 22 |
| Natural C | 62 | 100 | | | | | | | | |
| Natural B | 62 | | 100 | | | | | | | |
| Natural D | 62 | | | 100 | | | | | | |
| Syn/Nat Blend A | 58 | | | | 100 | | | | | |
| Syn/Nat Blend A | 52 | | | | | 100 | | | | |
| Natural F | 30 | | | | | | 100 | | | |
| Natural F | 62 | | | | | | | 100 | | |
| Natural F | 28 | | | | | | | | 100 | |
| Natural F | 62 | | | | | | | | | 100 |
| Synthetic Linear D | 62 | | | | | | | | | |
| Synthetic Linear C | 62 | | | | | | | | | |
| Synthetic Branched A | 62 | | | | | | | | | |
| Synthetic Linear F | 62 | | | | | | | | | |
| Natural A | 63 | | | | | | | | | |
| Synthetic Linear E | 63 | | | | | | | | | |
| Synthetic Branched B | 62 | | | | | | | | | |
| Emulsion Test for Sulfonates (10% in White Oil) | | | | | | | | | | |
| 70/30 w/Natural D(10%) | | fair | good | good | neg | neg | neg | neg | | |
| 90/10 w/Natural D (10%) | | | | good | | fair | | | fair | fair |
| Emulsion Test (20% in White Oil) | | | | | | | | | | |
| 70/30 w/Natural D (5%) | | good | good | good | poor | | fair | neg | | |
| 90/10 w/Natural D (5%) | | | | good | | good | | | good | good |
| Rust Test (20% in White Oil) | | | | | | | | | | |
| Rust (70/30 w/Natural D) | | | | | | | | | | |
| 4% | | pass | pass | fail | pass | | | | | |
| 5% | | pass | pass | fail | pass | | fail | | | |
| Rust (90/10 w/Natural D) | | | | | | | | | | |
| 5% | | fail | fail | fail | | fail | | | fail | fail |

| | | | | | | 99- | | | | |
|---|---|---|---|---|---|---|---|---|---|---|
| Formulation | 99-1 | 99-2 | 99-3 | 99-24 | 99-6 | 23 | 99-26 | 98-18 | 98-16 | 98-15 |
| Natural C | | | | | | | | | | |
| Natural B | | | | | | | | | | |
| Natural D | | | | | | | | | | |
| Syn/Nat Blend A | | | | | | | 85 | 80 | 75 | |
| Syn/Nat Blend A | | | | | | 50 | | | | |
| Natural F | | | | | | | | | | |
| Natural F | | | | | | | | | | |
| Natural F | | | | | | | | | | |
| Natural F | | | | | | | | | | |
| Synthetic Linear D | 100 | | | | | | | | | |
| Synthetic Linear C | | 100 | | | | | | | | |
| Synthetic Branched A | | | 100 | | | | 50 | | | |
| Synthetic Linear F | | | 100 | | | | | | | |
| Natural A | | | | | 100 | | | | | |
| Synthetic Linear E | | | | | | 100 | | | | |
| Synthetic Branched B | | | | | | | | 15 | 20 | 25 |
| Emulsion Test for Sulfonates (10% in White Oil) | | | | | | | | | | |
| 70/30 w/Natural D (5%) | neg | neg | fair | | neg | | fair | neg | poor | fair |
| 90/10 w/Natural D (5%) | | | | poor- | good | poor | | | | |
| | | | | neg | | | | | | |
| Emulsion Test (20% in White Oil) | | | | | | | | | | |
| 70/30 w/Natural D (5%) | fair | poor | good | | | | | fair | fair | good |
| 90/10 w/Natural D (5%) | | | | good | good | good | | | | |
| Rust Test (20% in White Oil) | | | | | | | | | | |
| Rust (70/30 w/Natural D) | | | | | | | | | | |
| 4% | | | | | | | pass | m. | fail | |
| | | | | | | | | pass | | |
| 5% | m. | m. | fail | | | | pass | pass | m. | fail |
| | pass | pass | | | | | | | pass | |
| Rust (90/10 w/Natural D) | | | | | | | | | | |
| 5% | fail | fail | fail | m. pass | pass | fail | fail | | | |

### Emulsification of Natural F and Syn/Nat Blend B

Blends of Natural F at both 28% and 62% and Syn/Nat Blend B active were made to determine their viability as PSRs. As can be observed in Table 2, blends of the products at a 70/30 composition with Natural D produced negative emulsions for all samples. An attempt was made to determine the break point of the emulsion of these samples and it was found that at a 90/10 composition with Natural D all products produced a fair emulsion, but did not possess a passing rust performance. In fact, at this ratio there is no differentiation from Natural C. Although the Natural F samples were no different from the Syn/Nat Blend B, the 28% active sulfonate content would require end-users to use a more dilute product, which was deemed not as attractive as Syn/Nat Blend B, which could be used undiluted.

While Synthetic Branched A (EW 520) passed the emulsion test alone, it did not pass the rust test. In contrast, Synthetic Branched A in combination with Syn/Nat Blend B changed the emulsion rating from negative to fair and yielded passing rust performance.

### Emulsification of Syn/Nat Blend B with Synthetic Petroleum Sulfonates

A sample of Syn/Nat Blend B was prepared and blended with Synthetic Branched A and Synthetic Branched B. In Table 3, a blend of Syn/Nat Blend B/Synthetic Branched B/Synthetic Branched A (40/24/36) is shown to yield the best results with a passing rust test and a poor emulsion. Although the emulsion performance of this blend is poorer than the Natural D/Syn/Nat Blend B/Synthetic Branched A (70/15/15) blend, it demonstrates there is a viable formulation of Syn/Nat Blend B with a synthetic petroleum sulfonate.

Although a combination of Syn/Nat Blend B and Synthetic Branched A (50/50) was the closest in rust and emulsion performance to the HMW-PS, combinations of other synthetic sulfonates with Synthetic Branched A were also investigated to determine their performance. As can be observed in Table 4, combinations of other synthetic and natural high molecular weight sulfonates do not possess both fair emulsions and passing rust performance. In fact, the linear synthetics (Synthetic Linear F, Synthetic Linear C, Synthetic Linear D) all failed the rust test. In contrast, the natural sulfonate Natural A does pass the rust test, but possesses a poorer emulsion than the Syn/Nat Blend B.

TABLE 2
Emulsification and Rust Properties of Natural F and Syn/Nat Blend B

| | Sulfonate | | | | | | | | | | |
|---|---|---|---|---|---|---|---|---|---|---|---|
| | 1 | 2 | 3 | 4 | 5 | 6 | 7 | 8 | 9 | 10 | 11 |
| Natural D | 70 | 70 | 70 | 70 | 70 | 70 | 70 | 80 | 80 | 80 | 80 |
| Natural C | 30 | | | | | | | 20 | | | |
| Natural F (28% | | 30 | | | | | | | 20 | | |
| Active)% | | | | | | | | | | | |
| Natural F (62% | | | 30 | | | | | | | 20 | |
| Active)% | | | | | | | | | | | |
| Syn/Nat Blend B | | | | 30 | | 15 | 22.5 | | | | 20 |
| Synthetic Branched A | | | | | 30 | 15 | 7.5 | | | | |
| Emulsion | fair | neg. | neg. | neg. | fair | fair | neg. | fair | neg. | neg. | neg |
| Rust | pass | | | | fail | pass | | pass | | | |

| | Sulfonate | | | | | | | | | | | | |
|---|---|---|---|---|---|---|---|---|---|---|---|---|---|
| | 12 | 13 | 14 | 15 | 16 | 17 | 18 | 19 | 20 | 21 | 22 | 23 | 24 |
| Natural D | 80 | 80 | 85 | 85 | 85 | 85 | 85 | 90 | 90 | 90 | 90 | 90 | 100 |
| Natural C | | | 15 | | | | | 10 | | | | | |
| Natural F | | | | 15 | | | | | 10 | | | | |
| Active)% | | | | | | | | | | | | | |
| Natural F | | | | | 15 | | | | | 10 | | | |
| Active)% | | | | | | | | | | | | | |
| Syn/Nat Blend B | 15 | 13 | | | | 15 | 11.25 | | | | 10 | 5 | |
| Synthetic Branched A | 5 | 7 | | | | | 3.75 | | | | | 5 | |
| Emulsion | poor | fair | fair | fair | neg. | neg. | fair | fair | fair | fair | fair | fair | fair |
| Rust | | fail | pass | fail | | | fail | fail | fail | fail | fail | fail | fail |

TABLE 3
Emulsification and Rust Properties of Syn/Nat Blend B
and Synthetic Branched Sulfonate

| | Sulfonate | | | | | | | | |
|---|---|---|---|---|---|---|---|---|---|
| | 1 | 2 | 3 | 4 | 5 | 6 | 7 | 8 | 9 |
| Syn/Nat Blend B | 15 | 25 | 30 | 30 | 40 | 40 | 50 | 50 | 50 |
| Synthetic Branched B | 28 | 20 | 28 | 35 | 24 | 60 | 20 | 30 | |
| Synthetic Branched A | 57 | 55 | 42 | 35 | 36 | | 30 | 20 | 50 |
| Sum | 100 | 100 | 100 | 100 | 100 | 100 | 100 | 100 | 100 |
| Emulsion | fair | poor | fair | fair | poor | fair | neg. | neg. | neg. |
| Rust | fail | fail | fail | fail | pass | fail | — | — | — |

TABLE 4
Evaluation of Other HMW Replacements

| | | Emulsion | Rust |
|---|---|---|---|
| Sample | Type | Test | Test |
| Natural C | nat. | good | pass |
| Synthetic Linear F/Synthetic Branched B | syn./syn. | poor | fail |
| Synthetic Linear C/Synthetic Branched B | syn./syn. | fair | fail |
| Synthetic Linear D/Synthetic Branched B | syn./syn. | poor | fail |
| Natural A/Synthetic Branched B | nat./syn. | poor | pass |
| Syn/Nat Blend B/Synthetic Branched B | nat./syn. | fair | pass |

The equivalent weight of Syn/Nat Blend B (527) is too high to be used directly as a replacement for Natural D. Its emulsion performance was tested in blends with available low equivalent weight materials.

Sulfonate samples were dissolved in white mineral oil (Carnation) at 6 wt % sulfonate. The properties of Carnation white mineral oil are:

| | Typical | |
|---|---|---|
| Properties | values | Method |
| Specific Gravity @ 25° C./25° C. | .829/.845 | ASTM D4052 |
| Kinematic Viscosity @ 40° C., cSt | 10.8/13.6 | ASTM D445 |
| Color, Saybolt | +30 Min. | ASTM D156 |
| Pour Point, ° C. | −7 | ASTM D97 |

Emulsions of the sulfonate in oil blends were mixed at 10 vol % into de-ionized water by using a stoppered graduated cylinder. The emulsions were evaluated on a scale of 0 to 5 with 0 representing a completely milky emulsion with no obvious separation of a cream layer from the emulsion layer. Five represents a separation of a significant oil layer on top of a watery layer with little emulsion present. A rating of 1 to 1.5 represents performance similar to Natural E. Ratings of 2 to 2.5 would be similar to Natural D.

Table 5 shows the results of testing several samples of Syn/Nat Blend B with Synthetic Branched A and Synthetic Branched B. Syn/Nat Blend B can be formulated at 10-20% into Synthetic Branched A. Care must be taken as too much Syn/Nat Blend B causes a catastrophic failure in the emulsion performance. Syn/Nat Blend B can be used at higher levels, around 30%, in Synthetic Branched B.

TABLE 5
Syn/Nat Blend B with Synthetic Sulfonates

| Sulfonate | Synthetic | Synthetic | Synthetic | Synthetic | Synthetic | Synthetic | Synthetic | Synthetic |
|---|---|---|---|---|---|---|---|---|
| % Blend B | Branched A | Branched A | Branched A | Branched A | Branched B | Branched B | Branched B | Branched B |
| 0 | 1.5 | 2.5 | 2.5 | 2 | 5 | 5 | 5 | 5 |
| 10 | 2.5 | 1.5 | 1 | 1.5 | 3.5 | 4 | 3 | 5 |
| 20 | 5 | 2 | 0.5 | 0.5 | 2.5 | 3 | 2 | 3.5 |
| 30 | 5 | 5 | 5 | 5 | 1 | 2 | 0.5 | 1.5 |
| 40 | 5 | 5 | 5 | 5 | 5 | 3.5 | 5 | 2 |
| 50 | 5 | 5 | 5 | 5 | 5 | 5 | 5 | 5 |
| 60 | | 5 | | | | 5 | | |
| 70 | | 5 | | | | 5 | | |
| 80 | | 5 | | | | 5 | | |
| 90 | | 5 | | | | 5 | | |
| 100 | | 5 | | 5 | | 5 | 5 | 5 |

Since Syn/Nat Blend B properties are more similar to high equivalent weight sulfonates, it was tested primarily with various low and mid equivalent weight sulfonates. The only improvement in emulsion performance, other than that found with the Synthetic Branched A and B, was with Synthetic Linear A where the performance only marginally approached Natural D.

TABLE 6

| Sulfonate | | | | Synthetic | Synthetic | Synthetic | | |
|---|---|---|---|---|---|---|---|---|
| % Blend B | Natural E | Natural G | Natural H | Linear A | Linear B | Linear C | Natural I | Natural J |
| 0 | 1.5 | 5 | 5 | 3 | 5 | 5 | 5 | 5 |
| 10 | 3 | 5 | 5 | 2.5 | 5 | 5 | 5 | 5 |
| 20 | 5 | 5 | 5 | 5 | 5 | 5 | 5 | 5 |
| 30 | 5 | 5 | 5 | 5 | 5 | 5 | 5 | 5 |
| 40 | 5 | 5 | 5 | 5 | 5 | 5 | 5 | 5 |
| 50 | 5 | 5 | 5 | 5 | 5 | 5 | 5 | 5 |
| 60 | | 5 | 5 | 5 | | | | |
| 70 | | 5 | 5 | 5 | | | | |
| 80 | | 5 | 5 | 5 | | | | |
| 90 | | 5 | 5 | 5 | | | | |
| 100 | | 5 | 5 | 5 | | | | |

Conclusions:

1. Syn/Nat Blend B can be formulated with Synthetic Branched A or B and the emulsion performance can be made comparable to Natural E and Natural D.

2. Other low and mid equivalent weight sulfonates tested did not improve the emulsion performance of Syn/Nat Blend B with the exception of Synthetic Linear A, which give a marginal emulsion.

In view of the many changes and modifications that can be made without departing from principles underlying the invention, reference should be made to the appended claims for an understanding of the scope of the protection afforded the invention.

What is claimed is:

1. An emulsifier composition suitable for mixing with oil to make lubricants comprising:
A) at least one product of the sulfonation of at least one of the following feedstocks:
i) a petroleum oil,
ii) a straight chain monoalkylbenzene,
iii) a straight chain dialkylbenzene,
iv) a branched chain monoalkylbenzene and
v) a branched chain dialkylbenzene, and
B) at least one straight or branched chain alkylaryl sulfonate salt.

2. The composition of claim 1 wherein the alkylaryl sulfonate salt is selected from the group consisting of monoalkylbenzenes and alkyl ortho-xylenes.

3. The composition of claim 1 wherein A is the product of the sulfonation of a petroleum oil, a straight chain monoalkylbenzene, and a straight chain dialkylbenzene.

4. The composition of claim 1 wherein A is the product of the sulfonation of a petroleum oil and a straight chain dialkylbenzene.

5. The composition of claim 3 wherein B is a synthetic branched chain monoalkylbenzene sulfonate salt.

6. The composition of claim 3 wherein B is a synthetic dodecyl ortho-xylene sulfonate salt.

7. The composition of claim 4 wherein B is a synthetic branched chain monoalkylbenzene sulfonate salt.

8. The composition of claim 4 wherein B is a synthetic dodecyl ortho-xylene sulfonate salt.

9. A lubricating or cutting fluid composition comprising:
A) a composition comprising:
i) at least one product of the sulfonation of at least one of the following feedstocks:
a) a petroleum oil,
b) a straight chain monoalkylbenzene,
c) a straight chain dialkylbenzene,
d) a branched chain monoalkylbenzene, and
e) a branched chain dialkylbenzene; and
ii) at least one straight or branched chain alkylaryl sulfonate salt; and
B) at least one oil selected from the group consisting of paraffinic and naphthenic petroleum oil and paraffinic and naphthenic refined petroleum oil in an amount about 50 wt % to about 95 wt % of the total oil based composition.

10. The composition of claim 9 wherein the alkylaryl sulfonate salt is selected from the group consisting of monoalkylbenzenes and alkyl ortho-xylenes.

11 The composition of claim 9 wherein i is the product of the sulfonation of a petroleum oil, a straight chain monoalkylbenzene, and a straight chain dialkylbenzene.

12. The composition of claim 9 wherein i is the product of the sulfonation of a petroleum oil and a straight chain dialkylbenzene.

13. The composition of claim 11 wherein ii is a synthetic branched chain monoalkylbenzene sulfonate salt.

14. The composition of claim 11 wherein ii is a synthetic dodecyl ortho-xylene sulfonate salt.

15. The composition of claim 12 wherein ii is a synthetic branched chain monoalkylbenzene sulfonate salt.

16. The composition of claim 12 wherein ii is a synthetic dodecyl ortho-xylene sulfonate salt.

17. The composition of claim 1 dispersed in aqueous media.
